(19) United States
(12) Patent Application Publication
(10) Pub. No.: US 2021/0395456 A1
(43) Pub. Date: Dec. 23, 2021

(54) FLUORIDE ION COLORIMETRIC SENSING PI FILM, PREPARATION METHOD THEREFOR AND APPLICATION THEREOF

(71) Applicant: South China University of Technology, Guangzhou (CN)

(72) Inventors: Shumei LIU, Guangzhou (CN); Yancheng WU, Guangzhou (CN); Jianqing ZHAO, Guangzhou (CN); Haohao HUANG, Guangzhou (CN)

(21) Appl. No.: 17/292,794

(22) PCT Filed: Oct. 18, 2019
(86) PCT No.: PCT/CN2019/112047

§ 371 Date: May 11, 2021

(30) Foreign Application Priority Data
Jan. 11, 2019 (CN) 201910025624.1

(51) Int. Cl. C08G 73/10; C08J 5/18; G01N 21/78; G01N 21/29

(52) U.S. Cl. CPC C08G 73/10; C08J 5/18; C08J 2333/24; G01N 21/29; G01N 21/78

(57) ABSTRACT

A fluoride ion (F⁻) colorimetric sensing polyimide (PI) film, a preparation method therefor and application thereof; the preparation method for a ^{F-} colorimetric sensing polyimide film comprises: mixing an aromatic diamine monomer and an aromatic dianhydride monomer in a strong polar aprotic organic solvent, adding a catalyst, vacuumizing at room temperature-introducing argon repeatedly for multiple times, and then reacting same under the protection of argon to obtain a polyimide solution; then preparing a PI fiber; dissolving the PI fiber in the strong polar aprotic organic solvent, thoroughly stirring to dissolve same and then applying same evenly on a clean glass plate, removing the solvent, cooling, then soaking same in hot water for film stripping so as to obtain the ^{F-} colorimetric sensing PI film. The PI film containing fluorene with hydroxy group may be directly cut into sheets for use such that sensor devices can be easily fabricated, and can be used for the detection of ^{F-}s, with a sensitivity reaching a detection limit of 10⁻⁴ mol/L, and a high selectivity.

### TECHNICAL FIELD

The present invention relates to a class of PI film sensing materials for the detection of F⁻, in particular to a class of colorimetric sensing, PI film sensing materials for the visual detection of F⁻, a preparation method therefor and the use thereof, and belongs to the field of materials science and technical field of ion detection technology.

### BACKGROUND ART

As the smallest anions, F⁻ play an important and basic role in many biological and chemical processes; an appropriate amount of F⁻ can prevent tooth decay and osteoporosis, but excessive intake of F⁻ will cause fluorosis, high concentrations of F⁻ can seriously harm the environment, and the presence of F⁻ seriously affects human life; in many cases, it is necessary to quickly and efficiently identify and detect the concentration of F⁻. The use of chemical substances that are sensitive to F⁻, by virtue of instruments, ultraviolet-visible spectroscopy, fluorescence spectroscopy and cyclic voltammetry, etc., are relatively common methods for determination; the chemical sensing substances for F⁻ that have been discovered currently are mostly small molecular compounds, which are formulated into solutions for determination, and have disadvantages such as inconvenient use and difficulty in recycling, etc., therefore, the development of simple and convenient methods for detecting F⁻ has very important practical significance.

With respect to taking the solid film as the sensing material, and by use of the color change that can only be observed visually after it is combined with F⁻, whereby the concentration of F⁻ is determined, no complicated instruments are required, and the operation is simple and convenient. Chinese patent for invention CN 201010202940.0 discloses that a F⁻-sensitive ligand alizarin complexant molecule single layer is loaded on a filter paper fiber with 10 layers of titanium dioxide film deposited on the surface to realize the color sensing and determination of fluoride ions, but this invention relates to the use of quantitative filter paper as a carrier, and the preparation method is complicated and can only be used once.

Chinese patent for invention CN 201610949644.4 discloses a poly 1,4-bis(4-(9,9-bis(N-carbazole-hexyl)fluorenyl)-1,2,3-triazolyl)benzene film obtained by using 2-bromo-9,9-(N-carbazole-hexyl)fluorene as a raw material, reacting same with trimethylsilylacetylene, and then subjecting same to electrochemical polymerization, which can be used as a fluorescent sensor film for detecting F⁻ with high sensitivity, but requires a special fluorescence detector. Currently, there is no colorimetric sensing solid film material that can detect F⁻ by visually observing color changes.

### SUMMARY OF THE INVENTION

An object of the present invention is to provide a colorimetric sensing PI film that can detect F⁻ by visually observing color changes;

another object of the present invention is to provide a preparation method for the F⁻ colorimetric sensing PI film;

yet another object of the present invention is to provide the use of the F⁻ colorimetric sensing PI film in the detection of F⁻.

In the present invention, a hydroxy-containing fluorene structure is introduced into the PI, and the hydroxyl group on the molecular structure can form a strong hydrogen bond interaction with F⁻, such that the hydroxyl group in the PI chain is deprotonated, and the intramolecular charge transfer effect is enhanced, resulting in strong absorption in the visible light region; after the PI film is soaked in a F⁻ solution and taken out, the color changes from yellow to green, the color change is obvious; by visually observing the color depth of the green, the corresponding concentration of F⁻ can be estimated, which can realize the quantitative detection of F⁻, without requiring other analytical chemistry instruments.

Usually F⁻ are dissolved in commonly used low-boiling-point solvents such as water or ethanol, methanol or acetone, etc., to be formulated into a solution for determination, which requires the sensing material to have good water resistance, solvent resistance, thermal stability, dimensional stability and a certain mechanical strength. The PI of the present invention is a class of high-performance polymer materials containing an imide ring in the main chain, and has excellent thermal stability, water resistance, solvent resistance, dimensional stability and mechanical strength, etc. The PI film containing fluorene with hydroxy group of the present invention has a sensitive color development reaction with respect to hydroxy, the concentration of hydroxy can be determined by visual observation, and the sensing effect can be recovered by means of a regeneration method, which can be used multiple times. The film may be directly cut into sheets, and thus a sensor device is easy to fabricate, and has a large application value.

The object of the present invention is achieved by means of the following technical solutions:

a F⁻ colorimetric sensing PI film, wherein the PI molecular structure contains fluorene with hydroxy groups, and has a general molecular structural formula of:

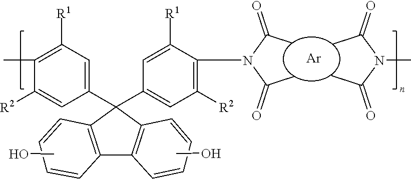

wherein n represents the average number of repeating structural units, with a value of 100 to 201; R¹ and R² are H or CH₃; Ar is one of the following general structural formulas:

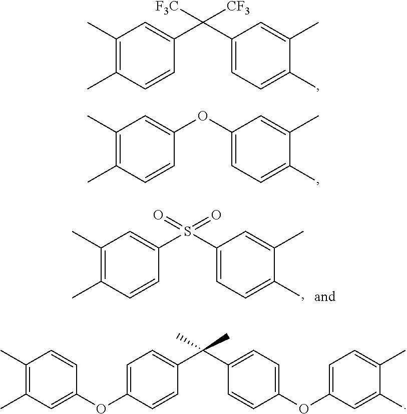

A preparation method for the fluoride ion colorimetric sensing PI film comprises the following steps:

(1) mixing an aromatic diamine monomer and an aromatic dianhydride monomer in a strong polar aprotic organic solvent, adding a catalyst, vacuumizing at room temperature-introducing argon repeatedly for multiple times, and then under the protection of argon, reacting same at 25-85° C. firstly for 2-12 hours, then increasing the temperature to 150-220° C. and continuously reacting for 12-48 hours to obtain a PI solution; dropwise adding the PI solution to ethanol to produce a fibrous precipitate, after the completion of the dropwise adding, leaving same to stand and filtering to remove the organic solvent, and drying the precipitate to obtain a fibrous PI, wherein the catalyst is one or two of isoquinoline, acetic anhydride, triethylamine and pyridine;

the structural formula of the aromatic diamine monomer is:

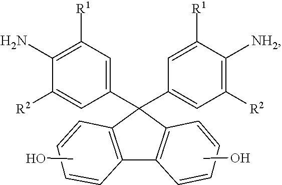

wherein R¹ and R² are H or CH₃;

the aromatic dianhydride monomer is 4,4′-(hexafluoroisopropylidene)diphthalic anhydride, 4,4′-oxydiphthalic anhydride, 3,3′,4,4′-diphenylsulfonetetracarboxylic dianhydride or 4,4′-(4,4′-isopropylidene diphenoxy)bis(phthalic anhydride);

(2) dissolving the fibrous PI obtained in step (1) in the strong polar aprotic organic solvent, controlling the solid content to 10-15 wt %, thoroughly stirring to dissolve same and then applying same evenly on a clean glass plate, vacuumizing multiple times until there are no bubbles, then increasing the temperature to remove the solvent, cooling, then soaking same in hot water for film stripping so as to obtain the fluoride ion colorimetric sensing PI film.

In order to further achieve the object of the present invention, preferably, the molar ratio of the aromatic diamine monomer to the aromatic dianhydride monomer is controlled to 1:0.9-1.1.

Preferably, the strong polar aprotic organic solvent is one or two of N,N-dimethylformamide, N-methylpyrrolidone, dimethylsulfoxide, N,N-dimethylacetamide and m-cresol.

Preferably, the amount of the catalyst used is 0.01-0.1 times the mole number of the aromatic diamine monomer.

Preferably, the drying of the precipitate in step (1) is to place the precipitate at 95-105° C. for vacuum drying for 8-12 hours; the number of times of vacuumizing at room temperature-introducing argon is two times; the amount of the ethanol used is 10-15 times the volume of the PI solution.

Preferably, the glass plate in step (2) is a silica glass plate; the temperature increasing to remove the solvent is increasing the temperature from room temperature to 70° C. for vacuum drying for 8-12 hours; then increasing the temperature from 70° C. to 120° C. for vacuum drying for 3-6 hours; and then increasing the temperature from 120° C. to 200° C. for vacuum drying for 2-3 hours.

The use of the fluoride ion colorimetric sensing PI film for the detection of F⁻: the PI film is cut into strips, soaked in a solution to be determined for 20-60 minutes, taken out and rinsed with ethanol, and the color change of the film is observed; only when it is soaked in a solution containing F⁻ does the color of the PI film change from yellow to green, there are noticeable color changes that can be recognized visually, and the PI film has an obvious colorimetric sensing effect on fluoride ions.

Preferably, the concentration of F⁻ in the solution to be determined is 10⁻⁴-0.1 mol/L; the PI film is cut into long strip sheets of 0.5×2 cm.

Preferably, after the color of the PI film changes from yellow to green, it is soaked in an ethanol solution containing 0.01-0.1 mol/L of trifluoroacetic acid for a regeneration treatment, after 5-20 minutes, the color of the film returns from green to the original yellow, it still has the same sensitive colorimetric sensing effect on fluoride ions; after repeating 10 times, the PI film has the same sensitive colorimetric sensing effect on fluoride ions.

In the present invention, 4,4′-(hexafluoroisopropylidene)diphthalic anhydride has the structural formula of:

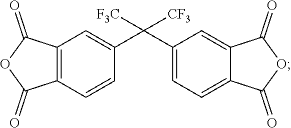 [SMILES: O=C1OC(=O)c2cc(C(c3ccc4c(c3)C(=O)OC4=O)(C(F)(F)F)C(F)(F)F)ccc21]

4,4′-oxydiphthalic anhydride (ODPA) has the structural formula of:

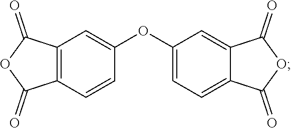 [SMILES: O=C1OC(=O)c2cc(Oc3ccc4c(c3)C(=O)OC4=O)ccc21]

3,3′,4,4′-diphenylsulfonetetracarboxylic dianhydride (DSDA) has the structural formula of:

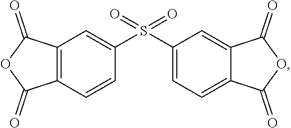 [SMILES: O=C1OC(=O)c2cc(S(=O)(=O)c3ccc4c(c3)C(=O)OC4=O)ccc21]

and 4,4′-(4,4′-isopropylidene diphenoxy)bis(phthalic anhydride) (BPADA) has the structural formula of:

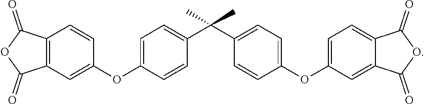

Compared with the prior art, the present invention has the following effects:

1. The PI film containing fluorene with hydroxy group of the present invention is insoluble in commonly used low-boiling-point solvents such as water and ethanol, methanol or acetone, etc.; in a nitrogen atmosphere, the temperature of 5% thermal weight loss reaches 500° C., the glass transition temperature reaches 370° C., the thermal expansion coefficient is less than 70 ppm/° C., the tensile modulus is greater than 3.0 GPa, the tensile strength is greater than 90 MPa, the elongation at break reaches 8%, which meets the requirements of fluoride ion sensing materials for water resistance, solvent resistance, thermal stability, dimensional stability and mechanical strength.

2. The PI film containing fluorene with hydroxy group of the present invention may be directly cut into sheets for use such that sensor devices can be easily fabricated, and can be used for the detection of F⁻, with a sensitivity reaching 10⁻⁴ mol/L, and a high selectivity.

3. The sensing effect of the PI film containing fluorene with hydroxy group of the present invention can be recovered by means of a regeneration method, which can be used for the detection of F⁻ multiple times.

### BRIEF DESCRIPTION OF THE DRAWINGS

FIG. 1 is the total reflection infrared spectrum of the PI film product obtained in Examples 1-4 of the present invention, where: a is the PI film product obtained in Example 1, b is the PI film product obtained in Example 2, c is the PI film product obtained in Example 3, and d is the PI film product obtained in Example 4.

FIG. 2 is a ¹H nuclear magnetic resonance spectrum of the PI obtained in Examples 1-4 of the present invention dissolved in deuterated dimethyl sulfoxide.

### DETAILED DESCRIPTION OF THE EMBODIMENTS

In order to better understand the present invention, the present invention will be further explained in combination with the drawings and the Examples, but the present invention is not limited thereto.

### Example 1

1.241 g of 4,4′-oxydiphthalic anhydride (ODPA) and 1.522 g of 2,7-dihydroxy-9,9-bis(4-aminophenyl)fluorene (AHF) were added into a 100 mL single-necked flask, 25 mL of m-cresol were added as a solvent, and 8 drops of isoquinoline were added as a catalyst, they were mixed evenly with magnetic stirring, vacuumized at room temperature-introducing argon twice, and then under the protection of argon, reacted at 85° C. and 200° C. for 12 hours, respectively; after the reaction was completed, the mixture was cooled to room temperature to obtain a viscous PI solution; it was dropwise added to 400 mL of ethanol to produce a fibrous precipitate, after the completion of the dropwise adding, it was left to stand and was filtered; the precipitate was vacuum dried at 100° C. for 10 hours to obtain a PI fiber; a part of the dried PI fiber was taken and dissolved in N,N-dimethylacetamide, with the solid content being controlled to 10%, after being thoroughly stirred and dissolved, it was evenly applied on a clean silica glass plate, and vacuumized multiple times until there were no bubbles, same was dried in a vacuum drying oven at 70° C. for 12 hours, 120° C. for 3 hours, and 200° C. for 3 hours, cooled, then soaked in hot water for film stripping so as to obtain a F⁻ colorimetric sensing ODPA-AHF type PI film.

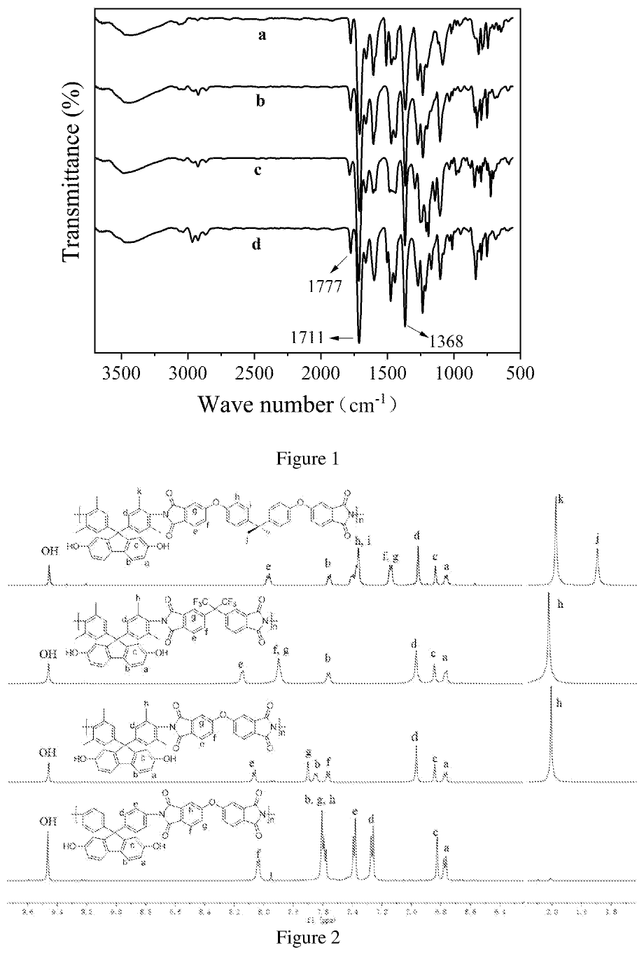

The color of the PI film was yellow, and the film was insoluble in water, ethanol, methanol and acetone; the temperature of 5% weight loss in a nitrogen atmosphere measured by a thermogravimetric analyzer (through TGA, thermogravimetric analysis) was 525° C.; the glass transition temperature thereof measured by a dynamic thermomechanical analyzer (through DMA, dynamic mechanical analysis) was 410° C.; the thermal expansion coefficient (CET) of the PI film measured by a static mechanical analyzer (TMA) was 60.57 ppm/° C.; the tensile modulus of the film was 4.3 GPa, the tensile strength was 101.5 MPa, and the elongation at break was 14%, as measured according to the GB/T 1040.3-2006 standard. The total reflection infrared (IR) spectrum of the film product is as shown in FIG. 1 by a; in the spectrum, there are broad characteristic absorption peaks between 3100-3600 cm⁻¹ corresponding to hydroxyl groups, characteristic peaks at 1777 cm⁻¹ and 1711 cm⁻¹ corresponding to asymmetric and symmetric stretching vibrations of C═O in the imide ring, respectively, and absorption peaks at 1368 cm⁻¹ corresponding to the stretching vibration of a C—N bond in the imide ring, and the other peaks are assigned as follows: 3063 and 3043 cm⁻¹ (stretching vibration of unsaturated C—H in aromatic ring), 1607 and 1509 cm⁻¹ (vibration of aromatic ring skeleton), 1337 cm⁻¹ (stretching vibration of C—N), and 1273, 1234 and 1084 cm⁻¹ (stretching vibration of C—O); a ¹H nuclear magnetic resonance spectrum thereof (600 MHz, DMSO-d₆) is as shown in FIG. 2 by a, chemical shifts (ppm) are assigned as δ=9.46 (s, 2H), 8.04 (d, J=7.8 Hz, 2H), 7.65-7.54 (m, 6H), 7.39 (d, J=8.5 Hz, 4H), 7.27 (d, J=8.5 Hz, 4H), 6.82 (s, 2H), and 6.77 (d, J=8.0 Hz, 2H); it is dissolved in N,N-dimethylformamide, the number average molecular weight thereof measured by a GPC method is 7.15×10⁴, PDI=1.64, and the average number of repeating structural units is 109. It can be speculated from the above that the molecular structural formula of the obtained PI is:

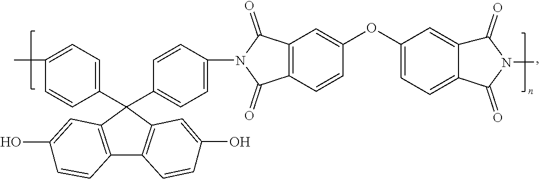

wherein n=109.

### Example 2

1.241 g of 4,4′-oxydiphthalic anhydride (ODPA) and 1.572 g of 2,7-dihydroxy-9,9-bis(3,5-dimethyl-4-aminophenyl)fluorene (DMAHF) were added into a 100 mL single-necked flask, 30 mL of N,N-dimethylformamide were added as a solvent, and 6 mL of acetic anhydride and 4 mL of pyridine were added as a catalyst, they were mixed evenly with magnetic stirring, vacuumized at room temperature-introducing argon twice, and then under the protection of argon, reacted at 25° C. for 6 hours, then heated up to 150° C. and continuously reacted for 18 hours, respectively; after the reaction was completed, the mixture was cooled to room temperature to obtain a viscous PI solution; it was dropwise added to 400 mL of ethanol to produce a fibrous precipitate, after the completion of the dropwise adding, it was left to stand and was filtered; the precipitate was vacuum dried at 105° C. for 8 hours to obtain a PI fiber; a part of the dried PI fiber was taken and dissolved in N,N-dimethylformamide, with the solid content being controlled to 10%, after being thoroughly stirred and dissolved, it was evenly applied on a clean silica glass plate, and vacuumized multiple times until there were no bubbles, same was dried in a vacuum drying oven at 70° C. for 6 hours, 120° C. for 5 hours, and 200° C. for 4 hours, cooled, then soaked in hot water for film stripping so as to obtain a F⁻ colorimetric sensing ODPA-DMAHF type PI film.

The color of the PI film was yellow, and the film was insoluble in water, ethanol, methanol and acetone; the temperature of 5% weight loss in a nitrogen atmosphere measured by TGA was 527° C., the glass transition temperature thereof measured by a DMA method was 452° C.; the CET of the PI film measured by TMA was 56.76 ppm/° C.; the tensile modulus of the film was 3.6 GPa, the tensile strength was 93.9 MPa, and the elongation at break was 11%, as measured according to the GB/T 1040.3-2006 standard. The total reflection IR spectrum of the film product is as shown in FIG. 1 by b, the data results are: IR (cm⁻¹): v=3100-3600 (stretching vibration of O—H), 3067, 3031 (stretching vibration of unsaturated C—H in aromatic ring), 2955, 2922, 2864 (stretching vibration of saturated C—H), 1776, 1713 (stretching vibration of C═O), 1605, 1472 (vibration of aromatic ring skeleton), 1363 (stretching vibration of C—N), and 1272, 1232, 1102 (stretching vibration of C—O); a ¹H nuclear magnetic resonance spectrum of the product (¹H NMR, 600 MHz, DMSO-d₆) is as shown in FIG. 2 by b, chemical shifts (ppm) are assigned as: δ=9.46 (s, 2H), 8.07 (d, J=8.3 Hz, 2H), 7.70 (s, 2H), 7.65 (d, J=8.1 Hz, 2H), 7.56 (d, J=8.2 Hz, 2H), 6.97 (s, 4H), 6.84 (s, 2H), 6.77 (d, J=7.8 Hz, 2H), and 2.01 (s, 12H); it is dissolved in N,N-dimethylformamide, the number average molecular weight measured by a GPC method is 1.43×10⁵, PDI=2.46, and the average number of repeating structural units is 201. It can be speculated from the above that the molecular structural formula of the obtained PI is:

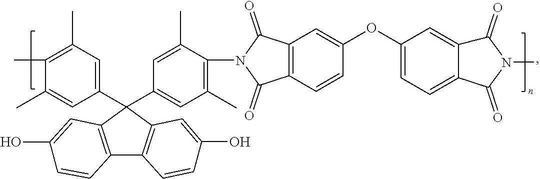

wherein n=201.

### Example 3

1.746 g of 4,4′-(hexafluoroisopropylidene)diphthalic anhydride (6FDA) and 1.921 g of 2,7-dihydroxy-9,9-bis(4-aminophenyl)fluorene (DMAHF) were added into a 100 mL single-necked flask, 30 mL of m-cresol were added as a solvent, and 10 drops of isoquinoline were added as a catalyst, they were mixed evenly with magnetic stirring, vacuumized at room temperature-introducing argon twice, and then under the protection of argon, reacted at 80° C. for 6 hours, then heated up to 220° C. and reacted for 6 hours, respectively; after the reaction was completed, the mixture was cooled to room temperature to obtain a viscous PI solution; it was dropwise added to 500 mL of ethanol to produce a fibrous precipitate, after the completion of the dropwise adding, it was left to stand and was filtered; the precipitate was vacuum dried at 95° C. for 12 hours to obtain a PI fiber; a part of the dried PI fiber was taken and dissolved in N,N-dimethylacetamide, with the solid content being controlled to 10%, after being thoroughly stirred and dissolved, it was evenly applied on a clean silica glass plate, and vacuumized multiple times until there were no bubbles, same was dried in a vacuum drying oven at 70° C. for 8 hours, 120° C. for 6 hours, and 200° C. for 2 hours, cooled, then soaked in hot water for film stripping so as to obtain a F colorimetric sensing 6FDA-DMAHF type PI film.

The color of the PI film was yellow, and the film was insoluble in water, ethanol, methanol and acetone; the temperature of 5% weight loss in a nitrogen atmosphere measured by TGA was 516° C., the glass transition temperature thereof measured by a DMA method was 456° C.; the CET of the PI film measured by TMA was 62.09 ppm/° C.; the tensile modulus of the film was 3.5 GPa, the tensile strength was 95.5 MPa, and the elongation at break was 8%, as measured according to the GB/T 1040.3-2006 standard. The total reflection IR spectrum of the film product is as shown in FIG. 1 by c, the data results are: IR (cm⁻¹): v=3100-3600 (stretching vibration of O—H), 3072, 3030 (stretching vibration of unsaturated C—H in aromatic ring), 2958, 2924, 2865 (stretching vibration of saturated C—H), 1783, 1714 (stretching vibration of C═O), 1609, 1479 (vibration of aromatic ring skeleton), 1366 (stretching vibration of C—N), and 1293, 1251, 1191, 1142, 1103 (stretching vibration of C—O); ¹H NMR of the product (600 MHz, DMSO-d₆) is as shown in FIG. 2 by c, chemical shifts (ppm) are assigned as: δ=9.46 (s, 2H), 8.15 (d, J=7.2 Hz, 2H), 7.90 (s, 4H), 7.56 (d, J=8.0 Hz, 2H), 6.97 (s, 4H), 6.84 (s, 2H), 6.77 (d, J=7.5 Hz, 2H), and 2.02 (s, 12H); it is dissolved in N,N-dimethylformamide, the number average molecular weight measured by a GPC method is 9.74×10⁴, PDI=1.76, and the average number of repeating structural units is 115. It can be speculated from the above that the molecular structural formula of the obtained PI is:

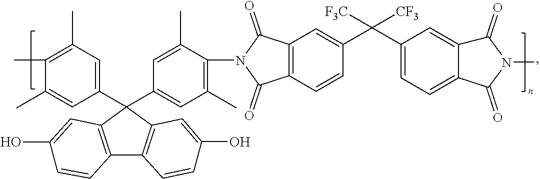

wherein n=115.

### Example 4

2.082 g of 4,4′-(4,4′-isopropylidene diphenoxy)bis(phthalic anhydride) (BPADA) and 1.834 g of 2,7-dihydroxy-9,9-bis(4-aminophenyl)fluorene (DMAHF) were added into a 100 mL single-necked flask, 30 mL of m-cresol were added as a solvent, and 10 drops of isoquinoline were added as a catalyst, they were mixed evenly with magnetic stirring, vacuumized at room temperature-introducing argon twice, and then under the protection of argon, reacted at 80° C. for 8 hours, then heated up to 200° C. and reacted for 12 hours, respectively; after the reaction was completed, the mixture was cooled to room temperature to obtain a viscous PI solution; it was dropwise added to 400 mL of ethanol to produce a fibrous precipitate, after the completion of the dropwise adding, it was left to stand and was filtered; the precipitate was vacuum dried at 100° C. for 10 hours to obtain a fibrous PI; a part of the dried PI fiber was taken and dissolved in N,N-dimethylformamide, with the solid content being controlled to 10%, after being thoroughly stirred and dissolved, it was evenly applied on a clean silica glass plate, and vacuumized multiple times until there were no bubbles, same was dried in a vacuum drying oven at 70° C. for 12 hours, 120° C. for 4 hours, and 200° C. for 3 hours, cooled, then soaked in hot water for film stripping so as to obtain a F⁻ colorimetric sensing BPADA-DMAHF type PI film.

The color of the PI film was light yellow, and the film was insoluble in water, ethanol, methanol and acetone; the temperature of 5% weight loss in a nitrogen atmosphere measured by TGA was 501° C., the glass transition temperature thereof measured by a DMA method was 370° C.; the CET of the PI film measured by TMA was 69.06 ppm/° C.; the tensile modulus of the film was 3.3 GPa, the tensile strength was 92.8 MPa, and the elongation at break was 13%, as measured according to the GB/T 1040.3-2006 standard. The total reflection IR spectrum of the film product is as shown in FIG. 1 by d, the data results are: IR (cm⁻¹): v=3100-3600 (stretching vibration of O—H), 3061, 3023 (stretching vibration of unsaturated C—H in aromatic ring), 2968, 2924, 2852 (stretching vibration of saturated C—H), 1777, 1709 (stretching vibration of C═O), 1608, 1460 (vibration of aromatic ring skeleton), 1365 (stretching vibration of C—N), and 1291, 1214, 1102 (stretching vibration of C—O); ¹H NMR of the product (600 MHz, DMSO-d₆) is as shown in FIG. 2 by d, chemical shifts (ppm) are assigned as: δ=9.45 (s, 2H), 7.97 (d, J=8.2 Hz, 2H), 7.56 (d, J=8.1 Hz, 2H), 7.38 (dd, J=20.7, 8.9 Hz, 8H), 7.14 (d, J=8.0 Hz, 4H), 6.95 (s, 4H), 6.84 (s, 2H), 6.76 (d, J=7.7 Hz, 2H), 1.97 (s, 12H), and 1.69 (s, 6H); it is dissolved in N,N-dimethylformamide, the number average molecular weight measured by a GPC method is 9.2×10⁴, PDI=1.52, and the average number of repeating structural units is 100. It can be speculated from the above that the molecular structural formula of the obtained PI is:

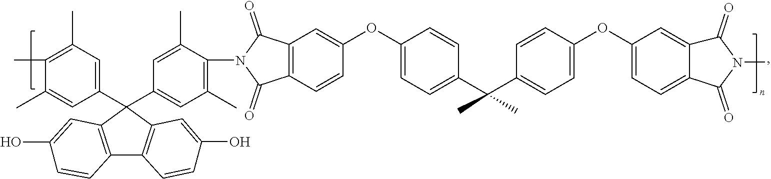

wherein n=100.

It can be seen from the above that the PI film obtained in Examples 1-4 is insoluble in commonly used low-boiling-point solvents such as water and ethanol, methanol or acetone, etc.; in a nitrogen atmosphere, the temperature of 5% thermal weight loss reaches 500° C., the glass transition temperature reaches 370° C., the thermal expansion coefficient is less than 70 ppm/° C., the tensile modulus is greater than 3.0 GPa, the tensile strength is greater than 90 MPa, the elongation at break reaches 8%, which meets the requirements of F⁻ sensing materials for water resistance, solvent resistance, thermal stability, dimensional stability and mechanical strength.

### Example 5: Sensitivity Experiment of PI Film to F⁻ Colorimetric Sensing

The PI film obtained in Example 4 was cut into long strip sheets of 0.5×2 cm, and tetrabutylammonium fluoride was dissolved in ethanol to formulate solutions with a F⁻ concentration of 10⁻⁶, 10⁻⁵, 10⁻⁴, 10⁻³, 10⁻² and 0.1 mol/L, respectively; the cut PI film strips were soaked in the solutions for 40 minutes, respectively, then taken out and rinsed with ethanol, and the color change of the film was observed; it was found that as the fluoride ion concentration increased, the color of the PI film gradually changed from light green to dark green; even when soaked in a fluoride ion solution with a concentration as low as 10⁻⁴ mol/L, it could also be observed that the color of the solution obviously changed to light green, and the obtained PI film had a more sensitive colorimetric sensing effect on F⁻. The PI films obtained in Example 1, Example 2 and Example 3 are all the same as Example 4, and the sensitivity for the detection of F⁻ reaches 10⁻⁴ mol/L.

### Example 6: Selectivity Experiment of PI Film to F⁻ Colorimetric Sensing

The PI film obtained in Example 2 was cut into long strip sheets of 0.5×2 cm, and soaked in 0.1 mol/L of a solution of Cl⁻, Br⁻, I⁻, AcO⁻, H₂PO₄⁻, HSO₄⁻, BF₄⁻, NO₃⁻ or ClO₄⁻ in ethanol, respectively, and after being soaked for 60 minutes, they were taken out and rinse with ethanol. It can be found that even if the concentration of these anions is as high as 0.1 mol/L, it still does not cause the color change of the PI film; however, it is mentioned in Example 5 that even when the concentration of F⁻ is as low as 10⁻⁴ mol/L, it still causes the color of the PI film to change to light green, indicating that the PI film has high selectivity for the recognition of F⁻. If the PI film obtained in Example 2 is changed to the PI films obtained in Example 1, Example 3 and Example 4, respectively, it still has high selectivity with respect to the colorimetric sensing effect of fluoride ions.

### Example 7: Regeneration of the Colorimetric Sensing Effect for PI Film to Fluoride Ions

The PI film obtained in Example 3 was cut into long strip sheets of 0.5×2 cm, then soaked in a 0.1 mol/L of fluoride ion-solution prepared by dissolving tetrabutylammonium fluoride in ethanol, after 60 minutes, they were taken out and air-dried, and the film turned green; they were soaked in 0.05 mol/L of trifluoroacetic acid in ethanol for a regeneration treatment, after 10 minutes, they were taken out and air-dried, and the color of the film returned from green to the original yellow, and still had the colorimetric sensing effect on F⁻; even when they were used more than 10 times, undergone a regeneration treatment each time, and then used for the detection of F⁻, they could still maintain the same color sensitivity. The PI films obtained in Example 1, Example 2 and Example 4 are all the same as Example 3, and can be used for the detection of F⁻ multiple times after the regeneration treatment.

It can be seen from Examples 5-7 that the PI film of the present invention may be directly cut into sheets for use such that sensor devices can be easily fabricated and used for the colorimetric sensing of F⁻, the determination sensitivity reaches 10⁻⁴ mol/L, and the selectivity is high and the sensing effect can be recovered by means of a regeneration method, which can be used for the detection of F⁻ multiple times. The F⁻ colorimetric sensor in the prior art is based on small molecule compounds (Chinese patent for invention CN 201010202940.0), which cannot be directly formed into a film, and needs to be loaded on a filter paper fiber with 10 layers of titanium dioxide film deposited on the surface, and the preparation method is very complicated, and can only be used once. Compared with the prior art, the PI film of the present invention has obvious convenience advantages, cost advantages, and a greater application value for the sensing determination of F⁻.

It should be noted that the present invention is not limited by the above examples; without departing from the spirit and scope of the present invention, the present invention will have various changes and improvements, and these changes and improvements fall within the protection scope claimed by the present invention; the protection scope claimed by the present invention is defined by the claims.

1. A F⁻ colorimetric sensing PI film, wherein the PI molecular structure contains fluorene with hydroxy groups, and has a general molecular structural formula of: 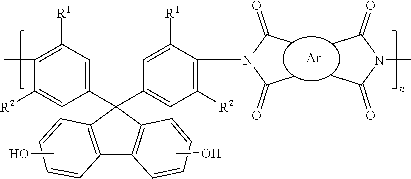
wherein n represents the average number of repeating structural units, with a value of 100 to 201; R¹ and R² are H or CH₃; Ar is one of the following general structural formulas:

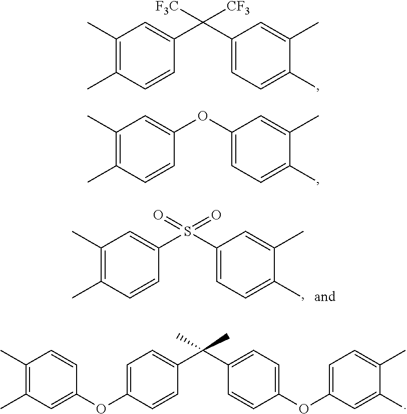

2. A preparation method for the F⁻ colorimetric sensing PI film according to claim 1, wherein the method comprises the following steps:
(1) mixing an aromatic diamine monomer and an aromatic dianhydride monomer in a strong polar aprotic organic solvent, adding a catalyst, vacuumizing at room temperature-introducing argon repeatedly for multiple times, and then under the protection of argon, reacting same at 25-85° C. firstly for 2-12 hours, then increasing the temperature to 150-220° C. and continuously reacting for 12-48 hours to obtain a PI solution; dropwise adding the PI solution to ethanol to produce a fibrous precipitate, after the completion of the dropwise adding, leaving same to stand and filtering to remove the organic solvent, and drying the precipitate to obtain a PI fiber, wherein the catalyst is one or two of isoquinoline, acetic anhydride, triethylamine and pyridine;
the structural formula of the aromatic diamine monomer is: 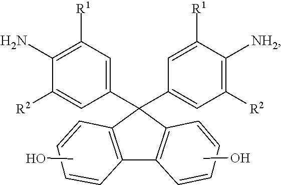
wherein R¹ and R² are H or CH₃;
the aromatic dianhydride monomer is 4,4′-(hexafluoroisopropylidene)diphthalic anhydride, 4,4′-oxydiphthalic anhydride, 3,3′,4,4′-diphenylsulfonetetracarboxylic dianhydride or 4,4′-(4,4′-isopropylidene diphenoxy)bis(phthalic anhydride);
(2) dissolving the PI fiber obtained in step (1) in the strong polar aprotic organic solvent, controlling the solid content to 10-15 wt %, thoroughly stirring to dissolve same and then applying same evenly on a clean glass plate, vacuumizing multiple times until there are no bubbles, then increasing the temperature to remove the solvent, cooling, then soaking same in hot water for film stripping so as to obtain the F⁻ colorimetric sensing polyimide film.

3. The preparation method for the F⁻ colorimetric-sensing PI film according to claim 2, wherein the molar ratio of the aromatic diamine monomer to the aromatic dianhydride monomer is controlled to 1:0.9-1.1.

4. The preparation method for the F⁻ colorimetric sensing PI film according to claim 2, wherein the strong polar aprotic organic solvent is one or two of N,N-dimethylformamide, N-methylpyrrolidone, dimethylsulfoxide, N,N-dimethylacetamide and m-cresol.

5. The preparation method for the F⁻ colorimetric sensing PI film according to claim 2, wherein the amount of the catalyst used is 0.01-0.1 times the mole number of the aromatic diamine monomer.

6. The preparation method for the F⁻ colorimetric sensing PI film according to claim 2, wherein the drying of the precipitate in step (1) is to place the precipitate at 95-105° C. for vacuum drying for 8-12 hours; the number of times of vacuumizing at room temperature-introducing argon is two times; the amount of the ethanol used is 10-15 times the volume of the PI solution.

7. The preparation method for the F⁻ colorimetric sensing PI film according to claim 2, wherein the glass plate in step (2) is a silica glass plate; the temperature increasing to remove the solvent is increasing the temperature from room temperature to 70° C. for vacuum drying for 8-12 hours; then increasing the temperature from 70° C. to 120° C. for vacuum drying for 3-6 hours; and then increasing the temperature from 120° C. to 200° C. for vacuum drying for 2-3 hours.

8. The use of the F⁻ colorimetric sensing PI film according to claim 1 for the detection of F⁻, wherein the PI film is cut into strips, soaked in a solution to be determined for 20-60 minutes, taken out and rinsed with ethanol, and the color change of the film is observed; only when it is soaked in a solution containing F⁻ does the color of the PI film change from yellow to green, there are noticeable color changes that can be recognized visually, and the PI film has an obvious colorimetric sensing effect on F⁻.

9. The use of the F⁻ colorimetric sensing PI film for the detection of F⁻ according to claim 8, wherein the concentration of fluoride ions in the solution to be determined is 10⁻⁴-0.1 mol/L; the PI film is cut into long strip sheets of 0.5×2 cm.

10. The use of the F⁻ colorimetric sensing PI film for the detection of F⁻ according to claim 8, wherein after the color of the PI film changes from yellow to green, it is soaked in an ethanol solution containing 0.01-0.1 mol/L of trifluoroacetic acid for a regeneration treatment, after 5-20 minutes, the color of the film returns from green to the original yellow, it still has the same sensitive colorimetric sensing effect on F⁻; after repeating 10 times, the PI film has the same sensitive colorimetric sensing effect on F⁻.
